(19) United States
(12) Patent Application Publication
(10) Pub. No.: US 2022/0098126 A1
(43) Pub. Date: Mar. 31, 2022

(54) METHYLSULPHONIC-BASED SOIL TREATMENT SYSTEMS AND METHODS

(71) Applicants: Micheal Jacob Frasier, Canbria, CA (US); Brian Hittle, Chandler, AZ (US)

(72) Inventors: Micheal Jacob Frasier, Canbria, CA (US); Brian Hittle, Chandler, AZ (US)

(21) Appl. No.: 17/491,239

(22) Filed: Sep. 30, 2021

Related U.S. Application Data
(60) Provisional application No. 63/085,600, filed on Sep. 30, 2020.

(51) Int. Cl. C05G 3/80; C09K 17/14; C05F 11/02; C05G 3/50

(52) U.S. Cl. CPC C05G 3/80; C05G 3/50; C05F 11/02; C09K 17/14

(57) ABSTRACT

A soil treatment mixture includes a methyl sulphonic acid component; a surfactant component; and a water component soil treatment composition and application method that improves infiltration rates, horizontal distribution, and water retention. A fulvic acid component may also be incorporated into the mixture. In a particular embodiment, the soil treatment mixture includes approximately 20% by weight of methylsulphonic acid component; 5% by weight of the surfactant component; 5% by weight of the fulvic acid component; and 70% of the water component.

### CROSS-REFERENCE TO RELATED APPLICATION

This application claims priority to U.S. Provisional Application No. 63/085,600 entitled “Methylsulphonic-Based Soil Treatment Systems and Methods”, filed Sep. 30, 2020, the entire disclosure of which is hereby incorporated by reference.

### TECHNICAL FIELD

The present invention generally relates to soil science and, more particularly, to systems, compositions, and methods for improving various characteristics of agricultural soils.

### BACKGROUND

Recent years have seen an increased interest in water quality, water penetration, and soil degradation in an agricultural context. Specifically, it has become apparent that currently known soil treatment methods are unsatisfactory in a number of respects.

Traditional methods of soil treatment employ strong acid-based materials, such as hydrochloric acid, sulfuric acid, and/or In-furic™ acid. Such chemicals are dangerous to humans and the environment due to their corrosiveness and toxicity.

In addition, these strong-acid materials displace chemistry in the soil. Through over-application, the treated soil can start to collapse and lose structure. When a soil collapses and becomes compacted and dense, water has a harder time entering the soil. The surface tension created by derogated soils seals off respiration of the soil. This leads to inefficient water distribution throughout the soil, which in turns affects the soil's ability to retain water. With the lack of pore space and structure in the soil, there can be a buildup of salts in the root mass. These salts become toxic and create significant problems in the plant's production and fertility, in turn effecting yields and performance. Since water infiltration is key to plant and soil health, such practices can lead to water run-off, severe puddling, and dust bowl conditions.

Accordingly, there is a need to address these and other limitations of prior art soil treatment systems and methods.

### BRIEF SUMMARY

To achieve the foregoing and other objectives in accordance with the present invention as broadly described herein, a soil treatment mixture in accordance with various embodiments of the present invention comprises: (1) a methylsulphonic acid component; (2) a surfactant component; and (3) a water component. In some embodiments, one or more additional components are included, such as fulvic acid, as described in further detail below.

Soil treatment mixtures in accordance with the present invention have been found to improve water efficiency and soil penetration. The mixture breaks down both calcium and salt chemicals bonds to convert them into more soluble forms. This allows salt and calcium to become more soluble, and salt is moved with water below the root zone. By reducing the salt in root zones and making the surrounding calcium molecules more soluble, mixtures in accordance with the present invention have open up the soil without leaving significant empty space, thus avoiding collapse in the soil due to the presence of empty pockets.

The present invention has a secondary effect of freeing locked minerals in the soil without losing them by making new, unbeneficial compounds, allowing the minerals and nutrients to be used by the plant for repairs, growth, and fertility.

### BRIEF DESCRIPTION OF THE DRAWING FIGURES

These and other features, aspects, and advantages of the present invention will become better understood with reference to the following description, appended claims, and accompanying drawings, where:

FIG. 1 is a flowchart illustrating a method of preparing a soil treatment mixture in accordance with various embodiments.

### DETAILED DESCRIPTION OF PREFERRED EXEMPLARY EMBODIMENTS

The present subject matter generally relates to a soil treatment composition and application method that dramatically improves infiltration rates, horizontal distribution, and water retention. As a preliminary matter, it will be understood that the following detailed description is merely exemplary in nature and is not intended to limit the inventions or the application and uses of the inventions described herein. Furthermore, there is no intention to be bound by any theory presented in the preceding background or the following detailed description. In the interest of brevity, conventional techniques and components related to chemical mixtures, soil hydrology, and the like need not be described in detail herein.

In general, a soil treatment mixture in accordance with the present invention comprises: (1) a methylsulphonic acid component; (2) a surfactant component; and (3) a water component. In some embodiments, one or more additional components are included, such as fulvic acid, as described in further detail below.

Methylsulphonic acid—also referred to as “methane sulphonic acid” or “MSA”—is, at room temperature, a clear, colorless, hygroscopic liquid. It is a simple alkylsulfonic acid with the chemical formula CH₄O₃S and CAS Number 75-75-2.

The surfactant component may comprise a variety of surfactant compounds known in the art. A surfactant is, in general, a surface-active agent or substance that reduces the surface tension of a liquid in which it is dissolved, thereby improving its wetting properties. In the context of soil treatments, surfactants are designed to increase infiltration rates, improve water retention, and improve horizontal water distribution.

In one non-limiting embodiment, the surfactant component comprises a dialkyl sulfosuccinate mixed with ethanol, such as one of the Cola® Wet DOSS surfactants manufactured by Colonial Chemical, Inc. Any other suitable surfactant known in the art may be used.

In another embodiment, the soil treatment mixture further includes an fulvic acid component. Fulvic acid is a natural acidic organic polymer that acts as an anionic surfactant that is extracted from humus found in soil, sediment, or aquatic environments. It is a strong acid with pH of 1.0, a mean chemical formula of C₁₃₅H₁₈₂O₉₅N₅S₂, and a CAS number of 479-66-3. In the context of soil science, fulvic acid is a chelator that combines micronutrient metal ions to form larger organic modules that can be consumed by plants. It also increases the acidity of the soil and improves water infiltration.

The soil treatment mixture may include other useful components, such as macronutrients, micronutrients, and the like.

### Example Mixtures

In one embodiment, the methylsulphonic acid component is present in a range of between 10% and 30% by weight, the surfactant component is present in a range of between 5% and 15% by weight, and the water component is present in a range of between 60% and 80%. In a particular embodiment, wherein the methylsulphonic acid component is present in a range of between 15% and 25% by weight, the surfactant component is present in a range of between 1% and 5% by weight (or, more broadly, 2% and 8% by weight), the fulvic acid component is present in a range of between 2% and 8% by weight, and the water component is present in a range of between 60% and 80%.

In a particular embodiment, the soil treatment mixture includes approximately 20% by weight of methylsulphonic acid component; 5% by weight of the surfactant component; 5% by weight of the fulvic acid component; and 70% of the water component.

### Example Preparation Methods

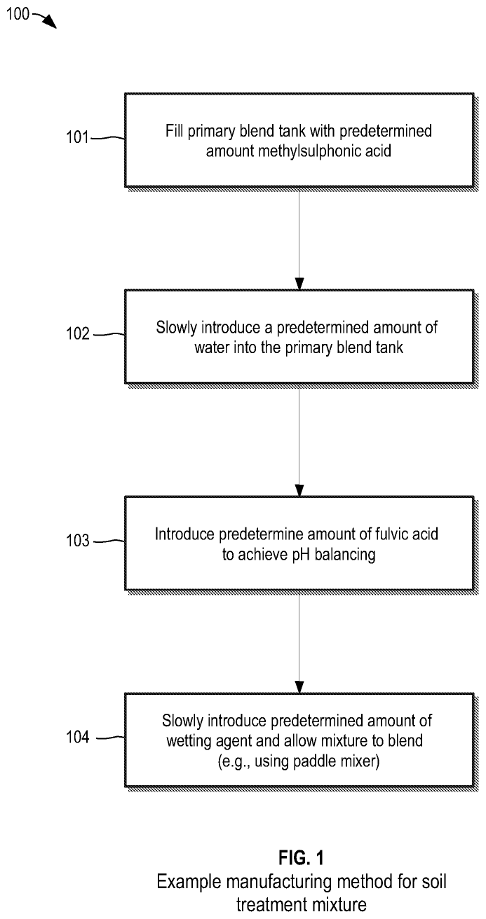

FIG. 1 is a flowchart illustrating a method 100 of preparing a soil treatment mixture in accordance with various embodiments. As shown, the four-step process begins by filling a blend tank with a predetermined amount of methylsulphonic add (step 101). The predetermined amount of this component may be selected to achieve a particular weight ratio based on the volume of material being produced, as detailed in the ratios described above.

Next, at step 102, a predetermined amount of water is slowly added to the blend tank in the illustrated embodiment, a predetermined amount of fulvic acid is added to the blend tank in step 103. The amount of fulvic acid may be selected to achieve a particular pH value of the finished mixture.

Finally, at step 104, a predetermined amount of wetting agent is slowly added to the blend tank and allowed to mix for a predetermined length of time. A paddle mixer or other suitable mixing system may be employed to accomplish uniform mixing.

### Example Soil Application

Application rates for the soil treatment mixture are preferably determined based upon the CEC (Cation Exchange Capacity) of the soil, which is based on is the total capacity of a soil to hold exchangeable cations. Application may be achieved in a variety of ways, such as through fertigation injections into an irrigation system. The following, non-limiting ranges of rates (Table 1) apply to an agricultural setting in the Western United States where there are high calcareous soils. Where there are issues with sodium and bicarbonate build-up in the soil, the amount applied may be increased as appropriate.

TABLE 1

| CEC | Amount | |
|---|---|---|
| 5-10 | 16-32 | oz/acre |
| 11-20 | 32-64 | oz/acre |
| 20-25 | 64-128 | oz/acre |
| 25+ | 128-384 | oz/acre |

In summary, an improved soil treatment mixture has been described which, among other things, breaks down both calcium and salt chemical bonds to convert them into more soluble forms. In this way, salt is moved with water below the root zone. This opens up the soil without causing soil collapse due to empty pockets.

In general, systems of the present disclosure are, in some instances, described in terms of functional and/or logical block components and processing steps. It should be appreciated that such block components may be realized by any number of hardware, software, and/or firmware components configured to perform the specified functions.

In addition, those skilled in the art will appreciate that embodiments of the present disclosure may be practiced in conjunction with any number of systems, and that the systems described herein are merely exemplary embodiments of the present disclosure. Further, the connecting lines shown in the various figures contained herein are intended to represent example functional relationships and/or physical couplings between the various elements. It should be noted that many alternative or additional functional relationships or physical connections may be present in an embodiment of the present disclosure.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. A soil treatment mixture comprising:
a methylsulphonic acid component;
a surfactant component; and
a water component.

2. The soil treatment mixture of claim 1, wherein the methylsulphonic acid component is present in a range of between 10% and 30% by weight, the surfactant component is present in a range of between 5% and 15% by weight, and the water component is present in a range of between 60% and 80%.

3. The soil treatment mixture of claim 1, further including a fulvic acid component.

4. The soil treatment mixture of claim 3, wherein the methylsulphonic acid component is present in a range of between 15% and 25% by weight, the surfactant component is present in a range of between 2% and 8% by weight, the fulvic acid component is present in a range of between 2% and 8% by weight, and the water component is present in a range of between 60% and 80%.

5. The soil treatment mixture of claim 4, consisting of approximately: 20% by weight of methylsulphonic acid component; 5% by weight of the surfactant component; 5% by weight of the fulvic acid component; and 70% of the water component.

6. The soil treatment mixture of claim 1, wherein the surfactant component comprises an anionic surfactant.

7. The soil treatment mixture of claim 6, wherein the surfactant comprises a dialkyl sulfosuccinate mixed with ethanol.
